(19) United States
(12) Patent Application Publication
(10) Pub. No.: US 2007/0133821 A1
(43) Pub. Date: Jun. 14, 2007

(54) Information processing apparatus including a speaker, and method of controlling volume of audio output from the speaker

(76) Inventor: Makoto Yamaguchi, Sagamihara-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/603,358

(22) Filed: Nov. 20, 2006

(30) Foreign Application Priority Data
Nov. 30, 2005 (JP) 2005-345904

(51) Int. Cl. H04R 3/00

(52) U.S. Cl. 381/96

(57) ABSTRACT

According to one embodiment, a vibration sensor senses a vibration level of a cabinet of an information processing apparatus as a first vibration level. A first determination unit determines whether a storage device is in operation in a specific state where audio is output from a speaker. A second determination unit determines whether the first vibration level exceeds a second vibration level when the storage device is in operation. A volume control unit controls the volume of the audio output from the speaker to lower the volume when the first vibration level exceeds the second vibration level.

### CROSS-REFERENCE TO RELATED APPLICATIONS

This application is based upon and claims the benefit of priority from Japanese Patent Application No. 2005-345904, filed Nov. 30, 2005, the entire contents of which are incorporated herein by reference.

### BACKGROUND

1. Field

One embodiment of the invention relates to an information processing apparatus such as a personal computer, which includes a speaker, and a method of controlling the volume of audio output from the speaker.

2. Description of the Related Art

Conventionally, various battery-operable portable personal computers such as notebook personal computers have been developed. Most of the personal computers include, for example, a pair of speakers. The personal computers are able to execute an audio playback application such as a music application. Executing the music application, music data can be played back from a recording medium such as a compact disc, a memory card and a hard disk, and the played-back music data can be output from the speakers.

In a personal computer such as a notebook personal computer, generally, speakers are incorporated in limited space in the cabinet of the computer. There is a possibility that the cabinet will resonate with the vibration of the speakers depending on the volume of audio output from the speakers. If the cabinet resonates, it is likely to generate a so-called fluttering sound and cause a storage device, such as a hard disk drive and an optical disk drive, using a recording medium rotated by a motor to malfunction.

Jpn. Pat. Appln. KOKAI Publication No. 2002-078071 (referred to as a prior art document hereinafter) discloses a speaker system including a plurality of speaker units having the same specification and arranged in parallel. The speaker units are operated by an amplifier. The speaker system is characterized in that using vibration information of any one of the speaker units, not only the one of the speaker units but also another speaker unit can be controlled. The vibration of the one of the speaker units is sensed by a vibration sensor. With the main aim of reducing the distortion of the speaker system and improving the characteristics thereof, information of the sensed vibration is fed back to thereby control the amplifier.

In a personal computer such as a notebook personal computer, which includes speakers, it is likely that the vibration of the speakers will cause a storage device using a recording medium rotated by a motor to malfunction. Such a malfunction is difficult to prevent simply by sensing the vibration of speakers themselves as in the speaker system disclosed in the prior art document.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a perspective view of an exemplary outward appearance of a personal computer according to an embodiment of the invention;

FIG. 2 is a block diagram of an exemplary system configuration of the personal computer shown in FIG. 1;

FIG. 3 is a block diagram of an exemplary configuration of a south bridge in the system configuration shown in FIG. 2;

FIG. 4 is a block diagram of an exemplary configuration of an embedded controller/keyboard controller IC (EC/KBC) in the system configuration shown in FIG. 2; and

FIG. 5 is a flowchart showing an exemplary procedure for controlling the volume of audio output from the personal computer according to the embodiment of the invention.

### DETAILED DESCRIPTION

Various embodiments according to the invention will be described hereinafter with reference to the accompanying drawings. In general, according to one embodiment of the invention, there is provided an information processing apparatus comprising a cabinet including a speaker that outputs audio and a storage device using a recording medium rotated by a motor, a vibration sensor which senses a vibration level of the cabinet as a first vibration level, a first determination unit configured to determine whether the storage device is in operation in a specific state where audio is output from the speaker, a second determination unit configured to determine whether the first vibration level exceeds a second vibration level which is a given vibration level when the first determination unit determines that the storage device is in operation, and a volume control unit configured to control volume of the audio output from the speaker to lower the volume when the second determination unit determines that the first vibration level exceeds the second vibration level.

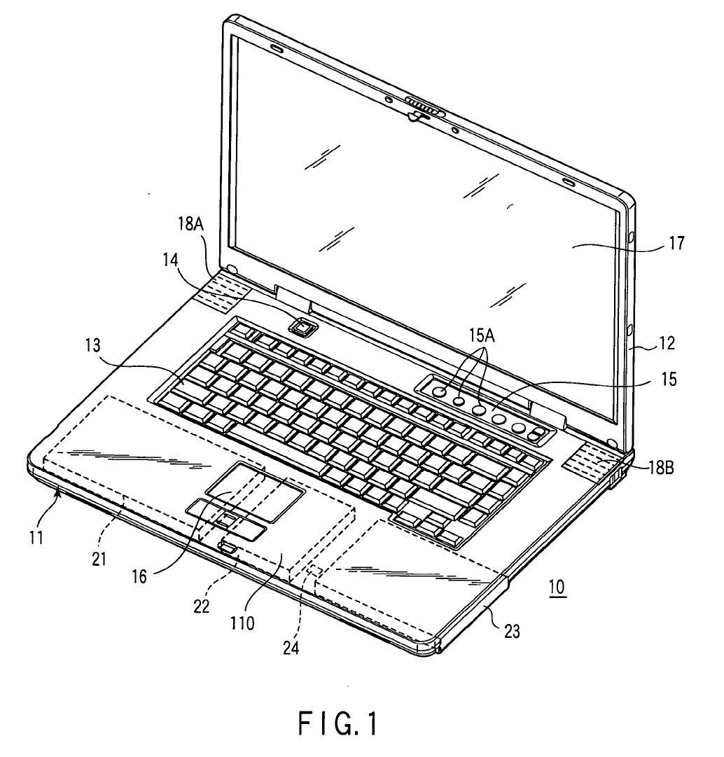

Referring first to FIGS. 1 to 4, an information processing apparatus according to an embodiment will be described. The information processing apparatus is implemented as, for example, a notebook personal computer 10.

FIG. 1 is a perspective view of the notebook personal computer 10 whose display unit is open. The computer 10 includes a cabinet 11 for the main body thereof and a display unit 12. The display unit 12 incorporates a display device that is configured by a thin-film transistor liquid crystal display (TFT-LCD) 17. The display screen of the LCD 17 is located in almost the central part of the display unit 12. The LCD 17 has, for example, a 17-inch horizontally oriented screen (wide screen), and the size (resolution) of the screen is, for example, 1440×900 pixels.

The display unit 12 is attached to the cabinet 11 such that it can turn between its open position and closed position. The cabinet 11 is shaped like a thin box. The cabinet 11 has on its top a keyboard (KB) 13, a power button 14, an input operation panel 15, a touch pad 16, and at least one speaker, e.g., a pair of speakers 18A and 18B. The power button 14 is used to power on/power off the computer 10. The input operation panel 15 is used as an input device for inputting an event corresponding to a depressed button. The input operation panel 15 includes a plurality of buttons (button switches) 15A for starting a function such as a playback/stop of music, control (increase/decrease) of the volume of audio output from the speakers 18A and 18B (or a headphone), and a playback of television (TV) broadcast program data.

Almost the front half of the top surface of the cabinet 11 serves as a palm rest 110. The touch pad 16 is provided in the central part of the palm rest 110. A rechargeable battery 21, a hard disk drive (HDD) 22 and an optical disk drive (ODD) 23 are incorporated in the cabinet 11 such that they are located to correspond to the palm rest 110. The HDD 22 and ODD 23 are storage devices using a magnetic disk and an optical disk, respectively. The magnetic disk and optical disk which are each rotated by a motor (e.g., a spindle motor), as a recording medium. It is known that such a storage device, unlike a memory device, is likely to malfunction due to a vibration applied thereto.

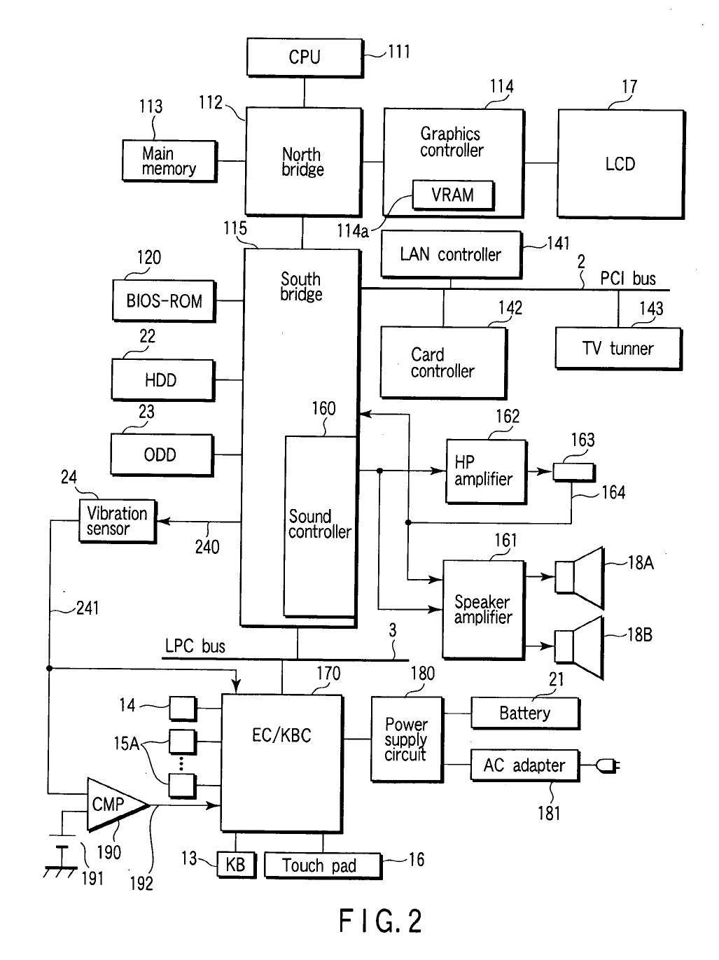

The cabinet 11 also incorporates a vibration sensor 24. When the vibration sensor 24 is in its enabling state, it senses the vibration of the cabinet 11 at fixed sampling periods and outputs a vibration level sensing signal 241 having a voltage corresponding to the level of the vibration (vibration level) (see FIG. 2). In the embodiment of the invention, the vibration sensor 24 senses the amplitude of a vibration as the vibration level. However, the vibration sensor 24 can sense the energy of a vibration as the vibration level. The vibration sensor 24 is provided on the bottom of the cabinet 11 and close to the HDD 22 and ODD 23.

FIG. 2 is a block diagram of a system configuration of the personal computer 10. The computer 10 includes a CPU 111, a north bridge 112, a main memory 113, a graphics controller 114, a south bridge 115 and an LCD 17. The computer 10 includes the HDD 22, the ODD 23, the vibration sensor 24, a BIOS-ROM 120, a local area network (LAN) controller 141, a card controller 142 and a TV tuner (TV tuner/capture unit) 143. The computer 10 also includes the speakers 18A and 18B, a speaker amplifier 161, a headphone amplifier (HP amplifier) 162, and a headphone jack (HP jack) 163. The plug of a headphone or an earphone can be inserted into the HP jack 163 (i.e., earphone jack 163). The computer 10 also includes an embedded controller/keyboard controller IC (EC/KBC) 170 and a power supply circuit 180.

The CPU 111 is a processor that controls the operation of the computer 10. The CPU 111 executes an operating system (OS) that is loaded into the main memory 113 from a boot device such as the HDD 22. The CPU 111 also executes various application programs (applications). The application programs include an audio playback application for playing back audio data and a TV application for, e.g., playing back/recording TV program data. In the embodiment of the invention, the audio playback application is a music application for playing back music data. The CPU 111 also executes a Basic Input/Output System (BIOS) stored in the BIOS-ROM 120. The BIOS is a program for control of hardware.

The north bridge 112 is a bridge device for connecting a local bus of the CPU 111 and the south bridge 115. The north bridge 112 includes a memory controller that controls access to the main memory 113. The north bridge 112 has a function of communicating with the graphics controller 114 via an accelerated graphics port (AGP) bus or the like.

The graphics controller 114 is a display controller that controls the LCD 17 used as a display monitor of the computer 10. The graphics controller 114 has a video memory (VRAM) 114a. The graphics controller 114 generates a video signal from display data written to the VRAM 114a. A display image to be displayed on the LCD 17 is generated from the video signal.

The south bridge 115 controls access to the BIOS-ROM 120. The BIOS-ROM 120 is a rewritable nonvolatile memory such as a flash ROM. As described above, the BIOS-ROM 120 stores the BIOS. The south bridge 115 controls a disk drive (I/O device) such as the HDD 22 and ODD 23. The south bridge 115 outputs a vibration sensor control signal 240 to turn on (enable) or turn off (disable) the vibration sensor 24. The south bridge 115 has a first function including control of the vibration sensor 24, which is necessary for preventing the HDD 22 and ODD 23 (storage devices) from malfunctioning due to the vibration of the cabinet 11, which is caused by the vibration of the speakers 18A and 18B.

The south bridge 115 includes a sound controller (audio controller) 160 as a sound source device. The sound controller 160 has a function of controlling the output of audio on the basis of encoded digital audio data to be played back. More specifically, the sound controller 160 has a decoding function of decoding the encoded digital audio data and a digital/analog converting function of converting the decoded digital audio data into, for example, a two-channel analog audio signal. The sound controller 160 supplies the audio signal to the speaker amplifier 161 and HP amplifier 162.

When a jack insertion signal 164 is inactive, the speaker amplifier 161 is enabled and amplifies the audio signal output from the sound controller 160. The speaker amplifier 161 operates the speakers 18A and 18B in response to the amplified audio signal. The jack insertion signal 164 becomes active (true) when the plug of a headphone (or earphone) is inserted into the HP jack 163 and becomes inactive (false) when it is not inserted. The jack insertion signal 164 indicates whether the plug of the headphone (or earphone) is inserted into the HP jack 163. In other words, the jack insertion signal 164 indicates whether audio is output from the headphone (earphone) or the speakers 18A and 18B. The jack insertion signal 164 is input to the south bridge 115 and speaker amplifier 161.

The HP amplifier 162 amplifies the audio signal output from the sound controller 160. In response to the amplified audio signal, the HP amplifier 162 operates the headphone (earphone) connected thereto through the HP jack 163. The sound controller 160 can be provided outside the south bridge 115 and, in this case, it is connected to the south bridge 115 as well as the amplifiers 161 and 162.

The south bridge 115 is connected to a Peripheral Component Interconnect (PCI) bus 2 and a Low Pin Count (LPC) bus 3. The south bridge 115 controls the devices on the PCI bus 2 and LPC bus 3. The PCI bus 2 is used as a system bus.

The HDD 22 is a storage device for storing various pieces of software and data. The software includes a TV application and a music application. The HDD 22 reads/writes data from/to magnetic a recording medium (magnetic disk), which is rotated by a motor, using a head (magnetic head). The HDD 22 stores the operating system (OS) in advance. In accordance with the BIOS stored in the BIOS-ROM 120, the OS is loaded into the main memory 113 and thus executed by the CPU 111. The TV and music applications run on the OS.

The ODD 23 is a drive unit that rotates an optical recording medium (optical disk) such as a compact disc (CD) and a digital versatile disc (DVD) using a motor. The ODD 23 reads/writes data from/to the optical disk using a head (optical head).

The LAN controller 141 and card controller 142 are connected to the PCI bus 2. The LAN controller 141 is a network controller (communication device) for connecting the computer 10 to a network. The card controller 142 controls a card device such as a PC card and a secure digital (SD) card each inserted into a card slot that is connected to the card controller 142.

The TV tuner 143 is connected to the PCI bus 2. The TV tuner 143 demodulates a TV broadcast signal, which is input through a TV antenna connector, into video data and audio data. In the TV tuner 143, the video data and audio data is compression-coded by the compression-coding method such as moving picture experts group 2 (MPEG2) and then output onto the PCI bus 2. The compression-coded video data output onto the PCI bus 2 is decoded on the basis of the TV application and displayed on the LCD 17 by the graphics controller 114. On the other hand, the compression-coded audio data output onto the PCI bus 2 is decoded by the sound controller 160 and converted into an analog audio signal. The analog audio signal is output to the amplifiers 161 and 162 as described above.

The EC/KBC 170 is a microcomputer in which an embedded controller (EC) for power management and a keyboard controller (KBC) for controlling the keyboard (KB) 13, touch pad 18, etc. are integrated on a single chip. The EC/KBC 170 has a power control function of operating in cooperation with the power supply circuit 180 and thus powering on the computer 10 in response to a user's depression of the power button 14. The EC/KBC 170 also has a function of powering on the computer 10 in response to a user's depression of one of the buttons 15, which is used for playing back TV broadcast program data. The power supply circuit 180 generates a system power supply voltage from an external power supply voltage that is applied via the rechargeable battery 21 or an AC adapter 181. The system power supply voltage is applied to each of the components of the computer 10.

The EC/KBC 170 is connected to the output terminal of a comparator 190. The comparator 190 compares the voltage level of the vibration level sensing signal 241 output from the vibration sensor 24 with a reference voltage level 191. The reference voltage level 191 is set to coincide with the voltage level of the vibration level sensing signal 241 that is output from the vibration sensor 24 when the sensor 24 senses a given reference vibration level. Specifically, the comparator 190 compares the vibration level (first vibration level) DVL sensed by the vibration sensor 24 with a reference (given) vibration level (second vibration level) RVL. The comparator 190 outputs an abnormal vibration sensing signal (specific signal) 192 that indicates the result of the comparison. The abnormal vibration sensing signal 192 is sent to the EC/KBC 170.

The EC/KBC 170 has a second function necessary for preventing the HDD 22 and ODD 23 from malfunctioning due to the vibration of the cabinet 11, which is caused by the vibration of the speakers 18A and 18B. The second function includes a function of controlling the volume of audio output from the speakers 18A and 18B using the abnormal vibration sensing signal 192 output from the comparator 190, while the sound controller 160 is controlling the output of audio. More specifically, the EC/KBC 170 has a function of decreasing the volume of audio output from the speakers 18A and 18B when the speakers 18A and 18B are operated, the HDD 22 or ODD 23 is in operation, and the abnormal vibration sensing signal 192 is active. The computer 10 can incorporate one speaker or three or more speakers.

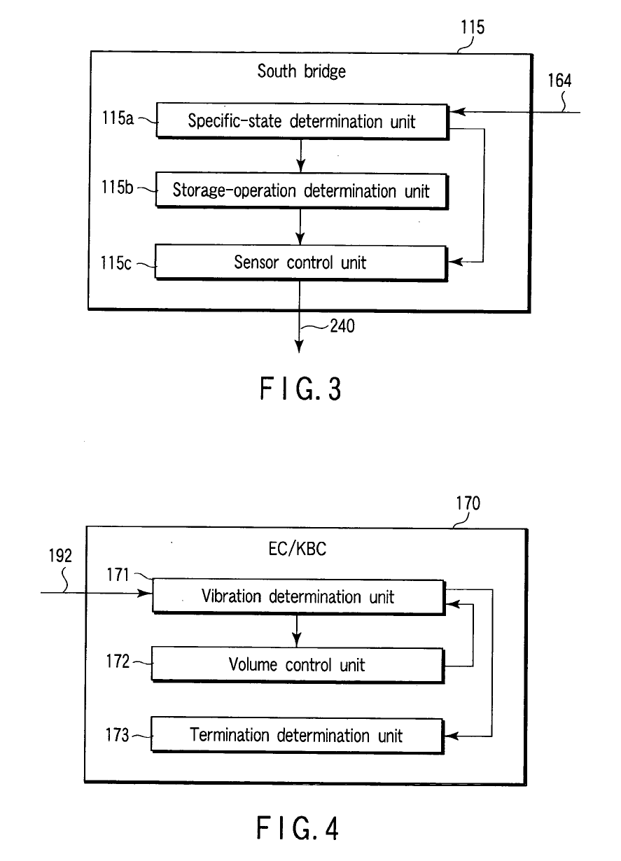

FIG. 3 is a block diagram of a configuration for achieving the first function of the south bridge 115. Referring to FIG. 3, the south bridge 115 includes a specific-state determination unit 115a, a storage-operation determination unit (first determination unit) 115b and a sensor control unit 115c.

The specific-state determination unit 115a determines whether a specific state in which audio is output from the speakers 18A and 18B is set at the time of execution of an application accompanied by the output of audio, such as a music application. In the embodiment of the invention, the determination of the specific-state determination unit 115a is performed on the basis of the state of the jack insertion signal 164. In the specific state, the storage-operation determination unit 115b determines whether at least one of the HDD 22 and ODD 23 is in operation. The sensor control unit 115c controls the operation of the vibration sensor 24 using the vibration sensor control signal 240.

FIG. 4 is a block diagram of a configuration for achieving the second function of the EC/KBC 170. Referring to FIG. 4, the EC/KBC 170 includes a vibration determination unit 171 (second determination unit), a volume control unit 172 and a termination determination unit 173.

The vibration determination unit 171 determines whether the vibration level DVL sensed by the vibration sensor 24 exceeds the reference vibration level RVL when at least one of the HDD 22 and ODD 23 is in operation. This determination is performed on the basis of the state of the abnormal vibration sensing signal 192 output from the comparator 190. When the vibration level DVL exceeds the reference vibration level RVL, the volume control unit 172 lowers the volume of the outputs of the speakers 18A and 18B. The termination determination unit 173 determines the termination of an application accompanied by the playback of audio.

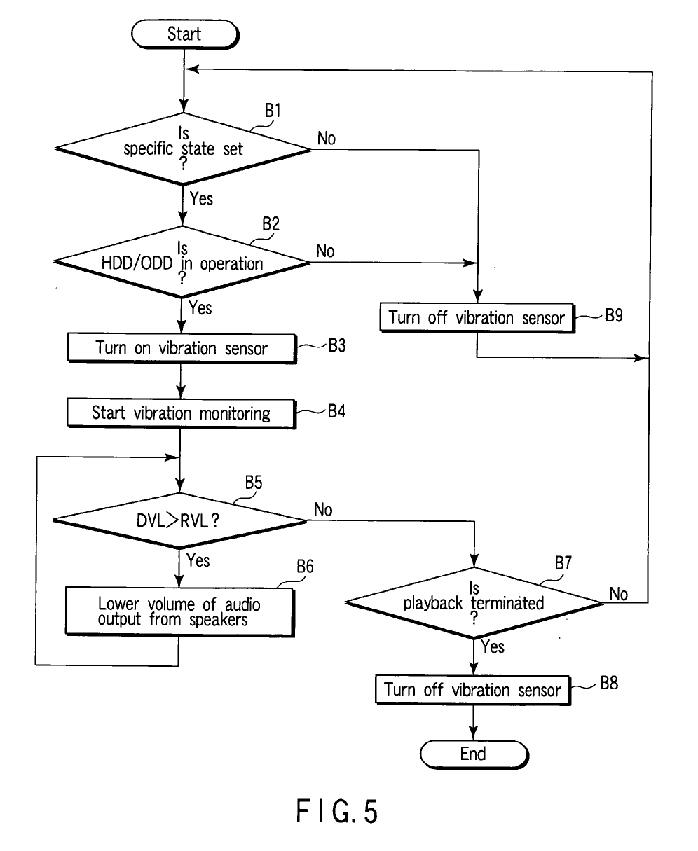

A procedure for performing a volume control process by the south bridge 115 and EC/KBC 170 will be described with reference to the flowchart shown in FIG. 5. The volume control process is performed during a period of execution of an application accompanied by the playback of audio (the operation of the sound controller 160).

Assume now that a music application starts to be executed (music is played back) under the control of the OS. The south bridge 115 and EC/KBC 170 start to perform the volume control process in accordance with the procedure indicated in the flowchart of FIG. 5.

First, the specific-state determination unit 115a determines whether a specific state in which audio is output from the speakers 18A and 18B is set (block B1). The determination in block B1 is performed on the basis of the state of the jack insertion signal 164. As described above, the jack insertion signal 164 becomes active (true) when the plug of a headphone (or earphone) is inserted into the HP jack 163 and becomes inactive (false) when it is not inserted. If the jack insertion signal 164 is inactive, the specific-state determination unit 115a determines that the above specific state is set.

If the specific state is set (block B1), the storage-operation determination unit 115b determines whether at least one of the HDD 22 and ODD 23 is in operation (block B2). If at least one of the HDD 22 and ODD 23 is in operation, the sensor control unit 115c turns on the vibration sensor 24 (sets the sensor 24 in an enabled state) (block B3). The sensor control unit 115c makes the vibration sensor control signal 240 active and turns on (enables) the vibration sensor 24.

Though not shown in FIG. 2 for reasons of the drawing, the vibration sensor control signal 240 is also sent to the EC/KBC 170. When the vibration sensor control signal 240 is active, the EC/KBC 170 determines that the vibration sensor 24 turns on. In order to check whether there is possibility that the vibration of the speakers 18A and 18B will have an adverse influence on the storage device in operation, the EC/KBC 170 starts an operation to monitor the vibration sensed by the vibration sensor 24 (vibration monitoring) (block B4).

When the vibration sensor 24 is in its ON (enabled) state, it senses the vibration of the cabinet 11 with the vibration sensor 24 at fixed sampling periods. The vibration sensor 24 outputs a vibration level sensing signal 241 having a voltage corresponding to the level of the sensed vibration (vibration level). The comparator 190 compares the voltage level of the vibration level sensing signal 241 output from the vibration sensor 24 with the reference voltage level 191.

When the voltage level of the vibration level sensing signal 241 exceeds the reference voltage level 191, the comparator 190 outputs an active abnormal vibration sensing signal 192 of, e.g., logic “1”. In other words, when the vibration level DVL sensed by the vibration sensor 24 is higher than the reference vibration level RVL, the comparator 190 outputs an active abnormal vibration sensing signal 192 of, e.g., logic “1”. On the other hand, when the voltage level of the vibration level sensing signal 241 does not higher than the reference voltage level 191, the comparator 190 outputs an inactive abnormal vibration sensing signal 192 of logic “0”. In other words, when the vibration level DVL is not higher than the reference vibration level RVL, the comparator 190 outputs an inactive abnormal vibration sensing signal 192 of logic “0”. The signal 192 is sent to the EC/KBC 170.

When the EC/KBC 170 starts vibration monitoring, it serves as the vibration determination unit 171. On the basis of the logic state of the abnormal vibration sensing signal 192 output from the comparator 190, the vibration determination unit 171 determines whether the vibration level DVL of the cabinet 11 sensed by the vibration sensor 24 exceeds the reference vibration level RVL (block B5). When the logic of the abnormal vibration sensing signal 192 is “1”, the vibration determination unit 171 determines that the vibration level DVL of the cabinet 11 exceeds the reference vibration level RVL. On the other hand, when the logic of the abnormal vibration sensing signal 192 is “0”, the vibration determination unit 171 determines that the vibration level DVL of the cabinet 11 does not higher than the reference vibration level RVL.

As described above, the vibration sensor 24 is provided on the bottom of the cabinet 11 and close to the HDD 22 and ODD 23. When the vibration level DVL of the cabinet 11 sensed by the vibration sensor 24 exceeds the reference vibration level RVL (block B5), there is a strong possibility that a high-level vibration is applied to a storage device in operation. In this case, there is a strong possibility that the storage device in operation will malfunction due to the influence of vibration of the cabinet 11. The vibration of the cabinet 11 is generally generated by the output of audio from the speakers 18A and 18B (by the operation of speakers 18A and 18B).

When the vibration level DVL of the cabinet 11 exceeds the reference vibration level RVL (block B5), the volume control unit 172 controls the volume of audio output from the speakers 18A and 18B to lower the volume by a fixed level (e.g., one level) (block B6). This control is performed by sending a command indicating that the volume of audio is lowered by one level from the volume control unit 172 to, for example, the OS. With the operation of the OS performed by the command, the volume of audio output from the speakers 18A and 18B is lowered by one level. The volume is lowered as in the case where a user depresses one (minus button) of the buttons 15A on the input operation panel 15 one time, which is used for lowering the volume of audio output from the speakers 18A and 18B (or a headphone).

The volume control unit 172 repeats the process of block B6 at fixed periods until the vibration level DVL of the cabinet 11 becomes lower than the reference vibration level RVL (block B5). In the embodiment of the invention, the volume of audio can be heightened or lowered by thirty-two levels at the maximum. Repeating the process of block B6 makes the vibration level DVL of the cabinet 11 lower than the reference vibration level RVL. Thus, the cabinet 11 can be prevented from resonating with the vibration of the speakers 18A and 18B, and the storage device (HDD 22 or ODD 23) in operation can be prevented from malfunctioning.

The location of the vibration sensor 24 is not limited to the bottom of the cabinet 11. For example, the vibration sensor 24 can be provided on the top of the cabinet 11 and close to the HDD 22 and ODD 23. Further, the vibration sensor 24 can directly be attached to the HDD 22 or ODD 23. However, it is favorable that the vibration sensor 24 be detachable from the HDD 22 or ODD 23 if it is taken into consideration that the HDD 22 or ODD 23 is detached from the cabinet 11.

When the vibration level DVL of the cabinet 11 becomes lower than the reference vibration level RVL and the abnormal vibration sensing signal 192 becomes logic “0” (block B5), the termination determination unit 173 determines whether audio playback (music application) terminates or not (block B7).

If the audio playback does not terminate (block B7), the termination determination unit 173 causes the specific-state determination unit 115a to perform the process of the block B1. In contrast, if the audio playback terminates (block B7), the termination determination unit 173 controls the sensor control unit 115c to save power of the computer 10, and the sensor control unit 115c turns off the vibration sensor 24 (sets the sensor 24 in its disabled state) (block B8). Thus, the volume control process terminates during the execution of an application (music application) accompanied by audio playback.

A case where the above specific state is not set, or a case where audio is output not from the speaker 18A or 18B but from a headphone will be described. In this case, neither of the speakers 18A and 18B is operated and thus the cabinet 11 is not likely to be vibrated by the speakers 18A and 18B. When the specific state is not set (block B1), the specific-state determination unit 115a passes its control to the sensor control unit 115c. Thus, the sensor control unit 115c turns off the vibration sensor 24 to save power of the computer 10 (block B9). Then, the sensor control unit 115c returns the control to the specific-state determination unit 115a. Thus, the specific-state determination unit 115a performs the determination process of block B1 again.

A case where the storage-operation determination unit 115b determines that neither of the HDD 22 and ODD 23 is in operation in block B2 will be described. In this case, even though the cabinet 11 is vibrated by the vibration (operation) of the speakers 18A and 18B, the HDD 22 or ODD 23 is not likely to malfunction. When neither the HDD 22 nor the ODD 23 is in operation (block B2), the storage-operation determination unit 115b passes its control to the sensor control unit 115c. Thus, the sensor control unit 115c turns off the operation of the vibration sensor 24 to save power of the computer 10 (block B9). Then, the sensor control unit 115c returns the control to the specific-state determination unit 115a. Thus, the specific-state determination unit 115a performs the determination process of block B1 again.

In the foregoing embodiment of the invention, the volume control process is performed by the procedure indicated in the flowchart in FIG. 3 during the execution of a music application. However, the volume control process is also performed during the execution of an application accompanied by audio playback (an operation of the sound controller 160), such as a TV application.

While certain embodiments of the inventions have been described, these embodiments have been presented by way of example only, and are not intended to limit the scope of the inventions. Indeed, the novel apparatuses and method described herein may be embodied in a variety of other forms; furthermore, various omissions, substitutions are changes in the form of the apparatuses and method described herein may be made without departing from spirit of the inventions. The accompanying claims and their equivalents are intended to cover such forms or modifications as would fall within the scope and spirit of the inventions.

What is claimed is:

1. An information processing apparatus comprising:
a cabinet including a speaker that outputs audio and a storage device using a recording medium rotated by a motor;
a vibration sensor which senses a vibration level of the cabinet as a first vibration level;
a first determination unit configured to determine whether the storage device is in operation in a specific state where audio is output from the speaker;
a second determination unit configured to determine whether the first vibration level exceeds a second vibration level which is a given vibration level when the first determination unit determines that the storage device is in operation; and
a volume control unit configured to control volume of the audio output from the speaker to lower the volume when the second determination unit determines that the first vibration level exceeds the second vibration level.

2. The information processing apparatus according to claim 1, further comprising a comparator which compares the first vibration level and the second vibration level and outputs a specific signal indicating a result of comparison,
wherein the second determination unit monitors a state of the specific signal to determine whether the first vibration level exceeds the second vibration level.

3. The information processing apparatus according to claim 1, wherein the volume control unit lowers the volume of audio output from the speaker step by step until the first vibration level becomes lower than the second vibration level.

4. The information processing apparatus according to claim 1, further comprising a sensor control unit configured to control an operation of the vibration sensor, the sensor control unit setting the vibration sensor in an enabled state when the first determination unit determines that the storage device is in operation in the specific state.

5. The information processing apparatus according to claim 4, wherein the sensor control unit sets the vibration sensor in a disabled state during which period audio data is not played back.

6. The information processing apparatus according to claim 5, wherein the sensor control unit sets the vibration sensor in a disabled state when no audio is output from the speaker even though the audio data is played back.

7. The information processing apparatus according to claim 5, wherein the sensor control unit sets the vibration sensor in a disabled state even in the specific state when the first determination unit determines that the storage device is not in operation.

8. A method of controlling volume of audio output from a speaker in an information processing apparatus including a cabinet having the speaker and a storage device, the storage device using a recording medium rotated by a motor, the method comprising:
determining whether the storage device is in operation in a specific state where audio is output from the speaker;
determining whether a first vibration level, which is a vibration level of the cabinet sensed by a vibration sensor, exceeds a second vibration level which is a given vibration level when the storage device is in operation; and
lowering volume of the audio output from the speaker when the first vibration level exceeds the second vibration level.

9. The method according to claim 8, wherein:
the lowering is repeated until the first vibration level becomes lower than the second vibration level; and
the volume of audio output from the speaker is lowered step by step each time the lowering is performed.

10. The method according to claim 8, further comprising setting the vibration sensor in an enabled state when it is determined that the storage device is in operation in the specific state.
